(19) United States
(12) Patent Application Publication
(10) Pub. No.: US 2007/0008344 A1
(43) Pub. Date: Jan. 11, 2007

(54) Manipulation of Projected Images

(76) Inventor: German Medina, Cali (CO)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/423,704

(22) Filed: Jun. 12, 2006

Related U.S. Application Data
(60) Provisional application No. 60/595,162, filed on Jun. 10, 2005.

(51) Int. Cl. G09G 5/00

(52) U.S. Cl. 345/647

(57) ABSTRACT

Correction of distorted projections and other visual effects are displayed continuously for still and video images based on three-dimensional transformations that distort or overlay images projected in such a way that the displayed image manipulated. The technology used to remove the distortion is not hardware dependent, may be used with any display device, such as a projector, and is capable of interfacing with the user by remote control, a computer pointing device or any other input device capable of communicating commands to a processor for manipulation of an image.

### CROSS-RELATED APPLICATIONS

This application claims the benefit of U.S. Provisional Application No. 60/595,162 to German Medina, which was filed on Jun. 10, 2005, the disclosure of which is hereby incorporated by reference herein.

### FIELD OF THE INVENTION

The field relates to manipulation of projected images under computer control.

### BACKGROUND

It is known to manipulate images by zooming, positioning and straightening images to eliminate distortions introduced on a display, such as a CRT or projected image. Solutions for manipulating images are ordinarily based on manual manipulation, proprietary hardware or software that corrects distortions on a pixel by pixel basis based on the two dimensional presentation of the image on the display, such as a screen of a CRT or a projector screen. However, real-time manipulation of the input field in two dimensions on a pixel by pixel basis requires an inordinate amount of processor time and processing steps. This relegates real-time manipulation of input feeds to applications that are hardware specific. A software solution for real time manipulation of projected images is a long standing and unfulfilled need, which has technical application to projection of images for presentations, home theatre and for overlay of graphics on displays.

In U.S. Pat. No. 6,753,907, which is incorporated by reference herein in its entirety, a transform for pre-warping a distorted image to an undistorted image is provided. However, the application requires the use of a camera and a frame on the projection surface in order to derive the mapping for an optimal undistorted image. This means that the system may only be used with a special screen and camera attached to a computer. The pre-warping of the image to be projected is a two-step process, applying one transform to reduce the size of the image to fit the screen and applying a second transform to correct for distortions of the image based on misalignment between the projector and the screen. However, such use of a camera or a special frame may present a less efficient approach to transformation of images.

Adobe Photoshop®¹ and other image manipulation software programs are capable of applying complex transforms to manipulate still images one at time. Although macros may be created to apply to a set of still images, it is not possible to continuously apply these complex transforms, which are applied to still images in these programs, to streaming video or at real-time screen refresh rates. This is a longstanding and unresolved need for which no solution has been forthcoming.
¹Adobe Photoshop® is a registered trademark of Adobe Systems Incorporated.

### SUMMARY OF THE INVENTION

An image display system for manipulation of a distorted image by a user comprises a computer, a video display processor operatively coupled to the computer, a display operatively coupled to the video display processor, an input device operatively coupled to the computer and capable of manipulating the image, and a transformation processor capable of transforming the image on the display by the video display processor in three dimensions, when the user operates the input device to manipulate the image to remove distortions. The transformation processor may include a video hardware accelerator under control of a software program using at least a texture mapping coordinate, a vertical coordinate and a horizontal coordinate to remap the coordinates of the image. The system includes a user interface, which may allow the user to select one or more of a plurality of grid points, each of the plurality of grid points being associated with a point on the image. An input devices, such as a pointing device or mouse, may be used to select one or more of the grid points, for example.

One advantage of the system is that a user may be capable of selecting and moving one of the plurality of grid points using the user interface, such that moving one of the plurality of grid points automatically defines a transformation algorithm for the transformation processor that it subsequently applied to any image displayed by a projector or monitor. The image may be manipulated by the transformation algorithm and subsequent images may be continuously manipulated by the transformation algorithm, until the user redefines a new transformation algorithm using the user interface. The system is capable of manipulating the images or portions of the images in real time. Another advantage is that video accelerator hardware may be used to increase the refresh rate of any manipulated image using three-dimensional transformations based on a rotational transformation of a plane or the like. A wide variety of mathematical transforms may be applied to manipulated images using known transformation algorithms.

An input feed is capable of being manipulated in real time, which is defined as at least 24 times per second. A rate of 30 frames per second may be achieved using common video hardware accelerators found in conventional personal computers without any additional hardware for image manipulation in a projector.

One advantage is that display of a virtual monitor may be determined by the physics of light in three dimensions using well known 2-D to 3-D transformations. Manipulation of the displayed image, such as to correct for distortions in a projected image, are corrected using three dimensional mathematic transforms which greatly reduces the overhead on the processor compared to manipulations of two dimensional images using pixel by pixel displacement. The technology allows user input to a system that may comprise a personal computer, such as a Pentium® processor having a standard hard drive and system memory for use as a personal computer.²
²Pentium® is a registered trademark of Intel Corporation.

No special hardware other than the normal resident video card in the computer system needs to be installed in order to transform a video feed in real-time. The video card should have adequate video RAM memory, such as at least 32 megabytes, or more preferably at least 64 megabytes of video RAM, or other similar video image storage memory. The user interface provides the advantage of real-time feedback to the user as the displayed projection is stretched, rotated, resized, positioned, flipped and geometrically corrected from any computer on the network.

The term “manipulation,” or any of its variants, means any and all of the transformations mentioned herein, including stretching, rotating, resizing, repositioning, flipping, mirroring, and geometrically correcting. Manipulation may also include other types of transformations, such as increasing density, contrast, brightness, image color adjustment or any other transformation that may be implemented in software using a known transformation, so long as the manipulation may be implemented with a real-time refresh rate of at least 25 frames per second using standard video hardware.

An image generation sub-system may use the primary monitor's desktop image copying it to a secondary display (i.e. real or virtual), such as a secondary monitor or projector. In one example, available extensions of the computer's operating system, such as a Microsoft Windows® operating system, is used to manipulate the images displayed in a way that has not been done previously. Much interest has been generated from vendors who have previously tried but failed to implement a software-only solution to image manipulation in real time. In one example, the system uses Microsoft DirectX® technology³ to transform the image, pre-distorting an image in real time such that a projected image appears undistorted, even if projected on an irregular surface or a surface at an angle to the projector.
³Microsoft Windows® and Microsoft DirectX® are registered trademarks of Microsoft Corporation.

Herein, a computer is defined as any system, device or machine that is capable of accepting instructions from a user, calculating transformations of video images and outputting a video feed to a video display. One advantage is that the system may update the primary desktop's image to the secondary desktop for only the portion of the image that has changed. Another advantage is that the system may copy the information from a memory buffer instead of from the display device. These advantages reduce the load on the processor and are capable of increasing the practical refresh rates for the projected image. Yet another advantage is that three-dimensional algorithms may be applied in real time using the video hardware's acceleration processor that is common in video hardware of common personal computers.

An user interface is provided that permits the user to see changes in the images as they are applied using an input device such as a pointing device or a remote control, for example. One advantage is that no camera or special frame is required to correct distortions and apply transformations.

### BRIEF DESCRIPTION OF THE FIGURES

The drawings show examples of the present invention, which is not limited to the specific examples as represented in the drawings.

FIG. 1A shows a distorted image projected on a surface.

FIG. 1B shows an adjusted image that corrects for the distortion in the image of FIG. 1A using a mathematical transformation after user input.

FIG. 2A illustrates a misaligned image.

FIG. 2B illustrates realignment of the image by three dimensional mathematical transformation of the image.

FIG. 3A illustrates a projected image obscured by an obstacle.

FIG. 3B illustrates an image transformed to occupy less smaller area on the screen.

FIG. 4A illustrates a projected image distorted by projection onto a column.

FIG. 4B illustrates a transformed image as corrected by the user, which appears undistorted during projection on the column.

FIG. 5 illustrates the overlaying of one image on another image.

FIG. 6 illustrates multiple computers being used to control a projector located anywhere on a network.

FIGS. 7A and 7B illustrate flipping of an image to its mirror image as is required for changing from a reflecting screen to a backlit screen.

FIG. 8 illustrates another example of an image to be manipulated.

### DETAILED DESCRIPTION OF PREFERRED EMBODIMENTS OF THE INVENTION

The detailed description and the drawings provide some examples of the invention, but the invention should not be limited merely to the examples disclosed. Instead, the invention should be limited only by the claims that may eventually issue. Many variations in the system, changes in specific components of the system and uses of the system will be readily apparent to those familiar with the field based on the drawings and description provided.

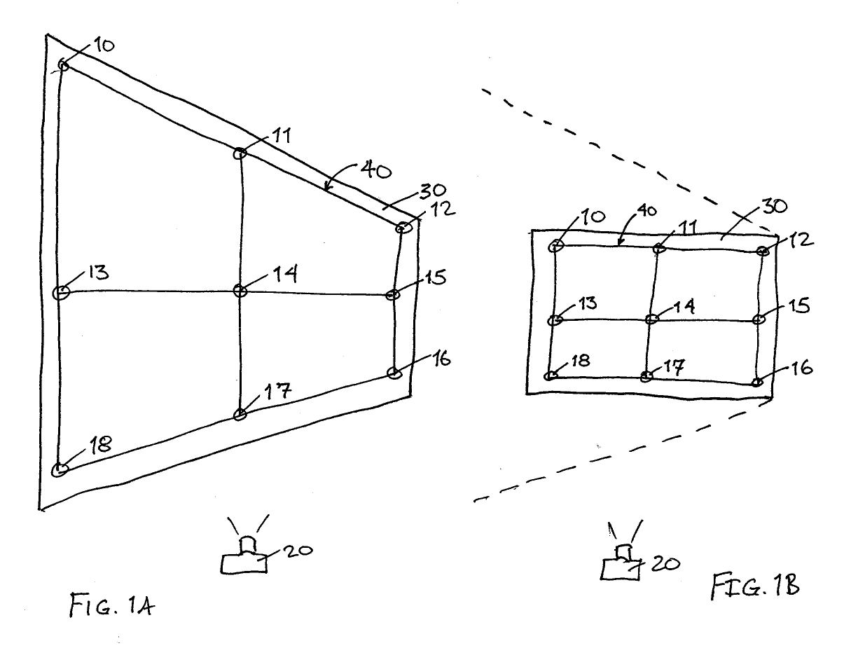

The image 30 in FIG. 1A is distorted, because the projector 20 is not aligned with the surface on which the image is projected. User input is used to correct the distortion without repositioning the projector. In one embodiment, a remote control may be used to correct the distortion in the image by sending a command to a processor capable of manipulating the image feed. In another embodiment, the distortion is corrected using the pointing device of a computer system, such as a mouse pad, track ball, or other pointing device, to select a point of the image frame and stretching the image to the undistorted view of the video feed. Certain points on the framed image 10-18 may be fixed either manually or automatically and others moved by eliciting and dragging the selected point to correct for the distortions. For example, a lower right point 16 may be selected by clicking on the circle shown on the lower right corner of the image, when a manual distortion correction program is operating. The manual distortion correction program displays a grid 40 overlaying the image 30. The grid 40 may be shown in its undistorted form on an user's computer monitor. By selecting a point 10-18 on the grid, using a mouse, for example, the user captures the point 10-18 and may manipulate the image by moving the mouse or other pointing device. By selecting one of the points on the outer periphery of the grid 40, the user is capable of stretching a corner or side in the direction of mouse movement.

In FIG. 1B, the distortion in the image has been remedied using a three dimensional transformation to fit a new non-distorted frame by intentionally pre-distorting the image being projected according to a mathematical transformation in real-time. In one example, the upper left point 10 and lower left point 18 were selected and moved, separately, to reduce the distance between them, resulting in the undistorted image 30 being immediately updated as the points 10, 18 were being dragged by the mouse. Alternatively, the upper right point 12 and lower right point 16 may be dragged further apart to stretch the image 30 and similarly correct the distortion. An overlaying process works by replacing the pixels of the actual image with transformed pixels of a pre-distorted image.

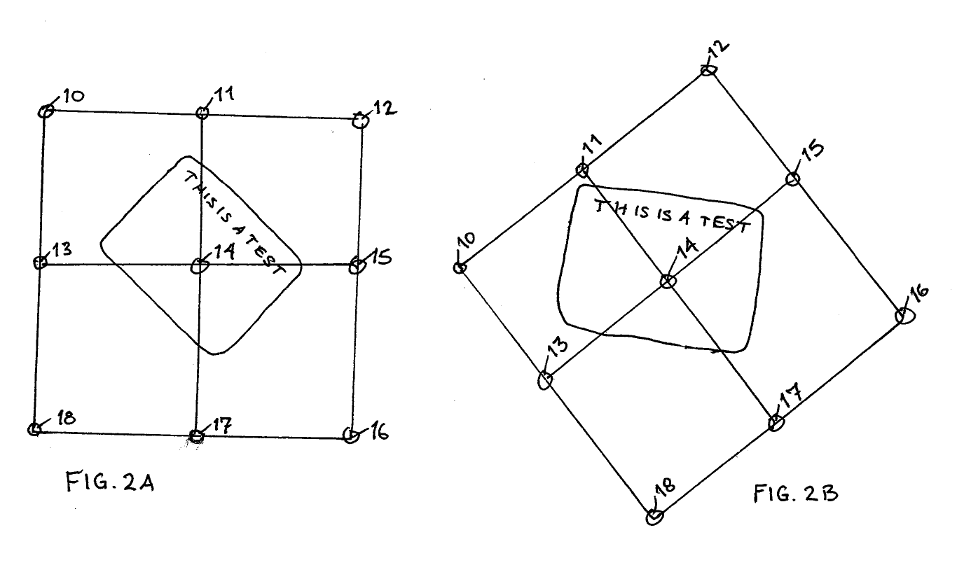

FIGS. 2A and 2B illustrate the result of user input to correct for a rotational distortion. One point of rotation or a line of rotation may be selected. Then, the image may be rotated around the point or the line, for example, by using a remote control or a pointing device of a computer. The output of the projector is transformed in real-time, distorting the projected image to correct for the misalignment of the projector. In one example, corner points 10, 12, 16, 18 may be individually selected and moved to result in a rotational correction of the image 30. Alternatively, a combination of key strokes and mouse movements may be used to rotate or zoom the image.

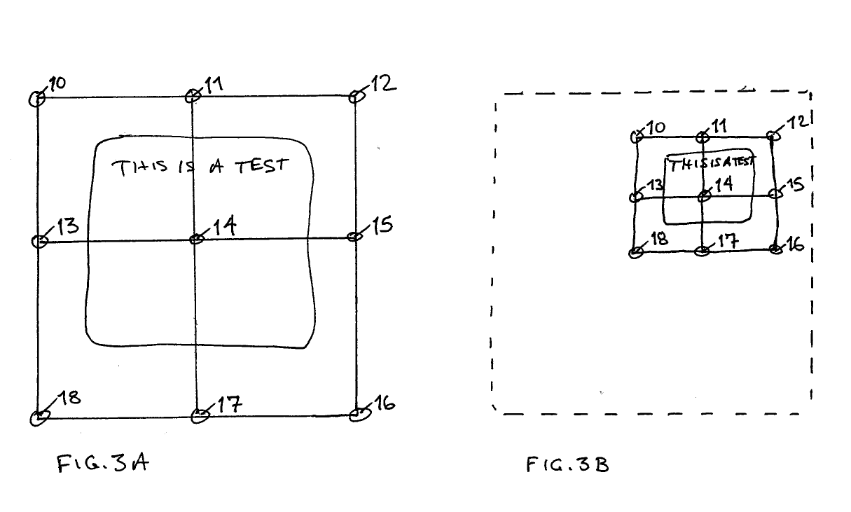

FIGS. 3A and 3B illustrate the result of user input to correct for an obscuring obstacle, in this case, a person. The user may resize and/or reposition the projected image 30. For example, the resizing of the image may use the shift key (held down) and the mouse to resize the image 30. The transformation used to perform this correction is capable of resizing and displacing away from any obstacle even if the distance between the projector and the screen and the focal distance of the lens would not permit the projector to adjust the size of the image sufficiently without repositioning of the projector, itself. By capturing the center point 14 while holding the shift key down and dragging the mouse down or up, the size is increased (up) or decreased (down). By capturing the center point 14 while not holding down the shift key (or some other key), movements of the mouse translate the entire image in the direction of the mouse movement. The movement is in real-time such that the user can readily see the changes being made to the image 30.

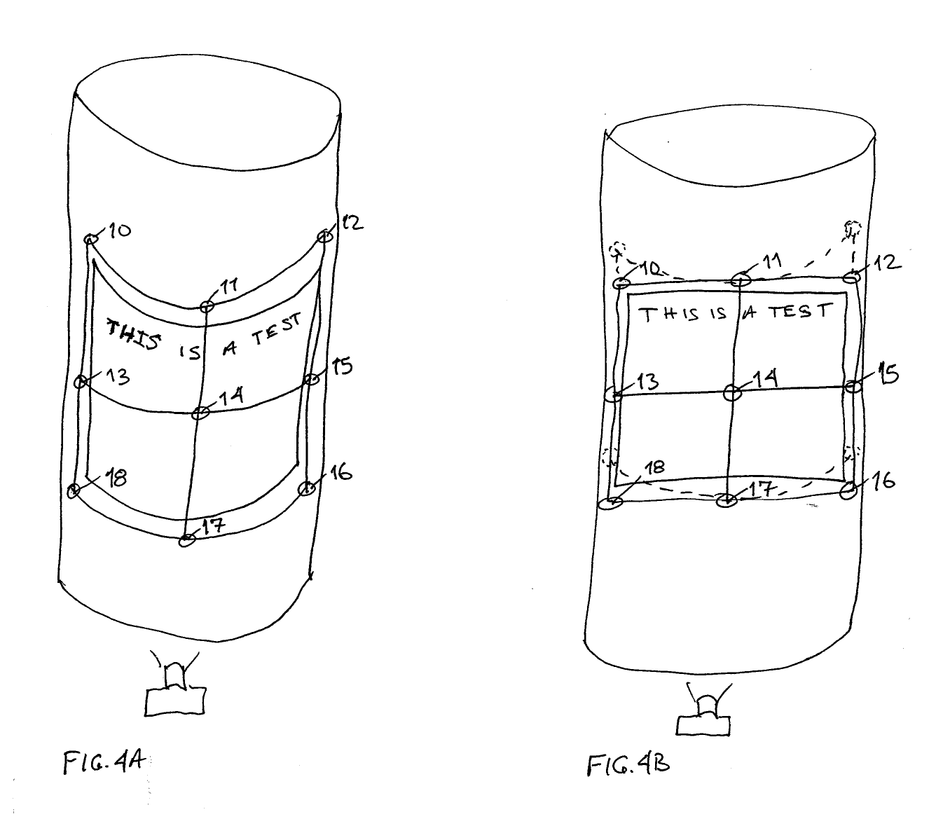

FIGS. 4A and 4B illustrate the technology for correcting three-dimensional geometric distortions caused by projection on curved surfaces. Transformation of the image is accomplished by user interaction, such as by use of a remote control or computer pointing device. The transformed image appears undistorted after the transformation, which intentionally distorts the image projected by the projector according to known transformations, for example. For example, two end points 10, 12, 18, 16 of the outer lines, which appear as arcs on the columnar surface, may be fixed and a respective edge point 11, 13, 15, 17 may be moved to stretch the respective line into an arc, which appears as a line on the projected image. The subsequent images are processed using a transform matrix to continuously pre-distort output to the second device, such as a secondary desktop.

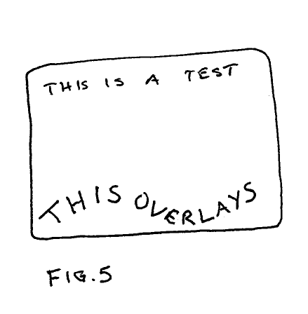

FIG. 5 illustrates the overlaying of graphics, video or other images over any portion of the projection area. Watermarks, logos or advertisements may be overlayed on a projected image or video feed. In one example, the overlaying process works by replacing the real pixels of the image manipulated to pre-distort those on the new image, video or text, or a mix of the original and the new image when there is a transparency involved. In one example, this process is accomplished by using Microsoft DirectX®. Both the update and the video portion may be transformed in real time and continuously by applying the transformation algorithm to the image sent to a secondary desktop by the operating system of the computer.

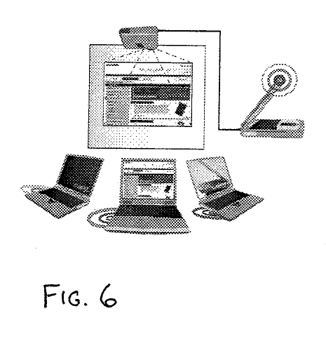

FIG. 6 illustrates a computer network of distributed computers. One of the computers is attached to a projector, which projects images on a surface. The technology allows a user on any of the networked computers to use the projector to project a video feed, including transformations of the video feed, as previously disclosed. The primary desktop is the networked computer, while the secondary desktop is in the computer connected to the projector, for example.

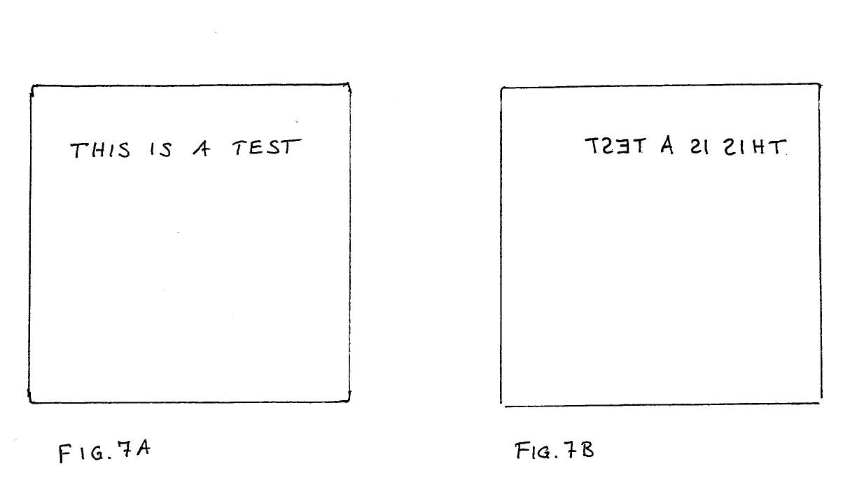

FIGS. 7A and 7B illustrate the flipping of an image or video feed to a mirror image using known transformations. Thus, a projector ordinarily used only with reflecting screens may also be used to project images on backlit transmission screens.

In another embodiment the virtual monitor system is used to overlay graphics on a display monitor or terminal. For example, streaming advertisements may be displayed over other programs or may be wrapped for flow in three dimensions through the display. Another application is to mask the mouse pointer, unless the mouse pointer is being used as a presentation pointer in a projected image on a screen. Another application is for displaying subtle features such as watermarks in presentations or displays. In one example, the overlaying process works by replacing the real pixels of the image with those on the new image, video or text, or a mix of the original and the new image when there is a transparency involved. In one example, this process is accomplished by using Microsoft DirectX®.⁴ Such watermarking or subtle features may be invisible in the presentation; however, the watermark may be visible if the presentation is recorded with a video camera, for example. Alternatively, the watermarking or the subtle features may not be visible in a recording by a video camera or may be incomplete if recorded by a video camera. In yet another example, subtle features may be used to enhance the video images of the primary video feed.
⁴Microsoft DirectX® is a registered trademark of Microsoft Corporation.

In one example, a plane is delimited by a rectangle, as shown in FIG. 9. The actual pixels of the desktop's image are shown displayed within the rectangle. In order to correctly pre-distort this image, the plane is rotated in three dimensions. Using Microsoft DirectX®⁵ to define a geometric object of this shape requires the use of its vertices. In this example, 4 points are defined, which are the plane corners. The following example provides a brief explanation of a transformation algorithm.
⁵Microsoft DirectX® is a registered trademark of Microsoft Corporation.

Initial Vertices

For example, assume a screen resolution of 1024×768 pixels. Initial corners are defined as:

| | | |
|---|---|---|
| Top/Left Vertex (v0) | x = 0, | y = 0 |
| Top/Right Vertex (v1) | x = 1024, | y = 0 |
| Bottom/Left Vertex (v2) | x = 0, | y = 768 |
| Bottom/Right Vertex (v3) | x = 1024, | y = 768 |

Final vertices are chosen by applying an arbitrary axis rotation to the plane. This rotation is going to be done making a vectoral transformation that multiplies each initial vertex by a special projection matrix to obtain a final vertex coordinate for each vertex.
Final Vertices

Let's stay that v0′, v1′, v2′ and v3′ are the final vertices and m is a projection matrix. Now, it follows that:

v0′=v0*m

v1′=v1*m

v2′=v2*m

v3′=v3*m

Each vertex has this information after the transformation:

x: Vertex horizontal position in pixels

y: Vertex vertical position in pixels

z: Pixel visibility value used to determine the pixels visibility (may be ignored in some examples)

w: Texture mapping value, which increases as the observer comes closer to the vertex.

The values obtained for each transformed vertex undergo another manipulation to prepare the image for display without distortion. The texture mapping value w is inverted and the horizontal position x and vertical position y are multiplied by the texture mapping value w, resulting in the following vertices.

| | | | | |
|---|---|---|---|---|
| v0′ | x = 0 | y = 348 | z = 1 | w = 1 |
| v1′ | x = 1024 | y = 0 | z = 1 | w = 1,8286 |
| v2′ | x = 0 | y = 768 | z = 1 | w = 1 |
| v3′ | x = 1024 | y = 768 | z = 1 | w = 1,8286 |

Projection Matrix

An example of a 4×4 projection matrix for the image is provided, as follows:

| | | | |
|---|---|---|---|
| 0.5469 | −0.3398 | 0 | −0.000442 |
| 0 | 0.5469 | 0 | 0 |
| 0 | 0 | 1 | 0 |
| 0 | 348 | 0 | 1 |

The matrix is calculated based on the initial plane corners and the new corner positions. The following variables are defined (in pixels):

| | | Sample |
|---|---|---|
| | | Image |
| Variable | Description | Value |
| x1 | Top/Left original corner horizontal position | 0 |
| y1 | Top/Left original corner vertical position | 0 |
| x2 | Bottom/Right original corner horizontal position | 1024 |
| y2 | Bottom/Right original corner vertical position | 768 |
| tx1 | Top/Left rotated corner horizontal position | 0 |
| ty1 | Top/Left rotated corner vertical position | 348 |
| tx2 | Top/Right rotated corner horizontal position | 1024 |
| ty2 | Top/Right rotated corner vertical position | 0 |
| tx3 | Bottom/Left rotated corner horizontal position | 0 |
| ty3 | Bottom/Left rotated corner vertical position | 768 |
| tx4 | Bottom/Right rotated corner horizontal position | 1024 |
| ty4 | Bottom/Right rotated corner vertical position | 768 |

The projection matrix is a result of the combination (matrix multiplication) of two matrices, a perspective matrix and a scaling matrix. The following is the way to calculate each of those 4×4 matrices:

$$\underline{Perspective matrix ( pm )}$$

$$pm [ 1 ] [ 1 ] = tx 2 - tx 1 + pm [ 1 ] [ 4 ] * tx 2$$

$$pm [ 1 ] [ 2 ] = ty 2 - ty 1 + pm [ 1 ] [ 4 ] * ty 2$$

$$pm [ 1 ] [ 3 ] = 0$$

$$pm [ 1 ] [ 4 ] = \frac{( ( tx 1 - tx 2 + tx 4 - tx 3 ) * ( ty 3 - ty 4 ) - ( ty 1 - ty 2 + ty 4 - ty 3 ) * ( tx 3 - tx 4 ) )}{( ( tx 2 - tx 4 ) * ( ty 3 - ty 4 ) - ( ty 2 - ty 4 ) * ( tx 3 - tx 4 ) )}$$

$$pm [ 2 ] [ 1 ] = tx 3 - tx 1 + pm [ 2 ] [ 4 ] * tx 3$$

$$pm [ 2 ] [ 2 ] = ty 3 - ty 1 + pm [ 2 ] [ 4 ] * ty 3$$

$$pm [ 2 ] [ 3 ] = 0$$

$$pm [ 2 ] [ 4 ] = \frac{( ( tx 2 - tx 4 ) * ( ty 1 - ty 2 + ty 4 - ty 3 ) - ( ty 2 - ty 4 ) * ( tx 1 - tx 2 + tx 4 - tx 3 ) )}{( ( tx 2 - tx 4 ) * ( ty 3 - ty 4 ) - ( ty 2 - ty 4 ) * ( tx 3 - tx 4 ) )}$$

$$pm [ 3 ] [ 1 ] = 0$$

$$pm [ 3 ] [ 2 ] = 0$$

$$pm [ 3 ] [ 3 ] = 1$$

$$pm [ 3 ] [ 4 ] = 0$$

$$pm [ 4 ] [ 1 ] = tx 1$$

$$pm [ 4 ] [ 2 ] = ty 1$$

$$pm [ 4 ] [ 3 ] = 0$$

$$pm [ 4 ] [ 4 ] = 1$$

$$\underline{Scaling matrix ( sm )}$$

$$sm [ 1 ] [ 1 ] = \frac{1}{( x 2 - x 1 )}$$

$$sm [ 1 ] [ 2 ] = 0$$

$$sm [ 1 ] [ 3 ] = 0$$

$$sm [ 1 ] [ 4 ] = 0$$

$$sm [ 2 ] [ 1 ] = 0$$

$$sm [ 2 ] [ 2 ] = \frac{1}{( y 2 - y 1 )}$$

$$sm [ 2 ] [ 3 ] = 0$$

$$sm [ 2 ] [ 4 ] = 0$$

$$sm [ 3 ] [ 1 ] = 0$$

$$sm [ 3 ] [ 2 ] = 0$$

$$sm [ 3 ] [ 3 ] = 1$$

$$sm [ 3 ] [ 4 ] = 0$$

$$sm [ 4 ] [ 1 ] = - x 1$$

$$sm [ 4 ] [ 2 ] = - y 1$$

$$sm [ 4 ] [ 3 ] = 0$$

$$sm [ 4 ] [ 4 ] = 1$$

The final vertex locations provided by the projection matrix, then, are used to map a secondary desktop image in the plane.
Desktop's Image Mapping

For example, the actual desktop image is copied to a Microsoft DirectX®⁶ texture to map it on the rotated plane using hardware acceleration, which provides for a very rapid transformation of the actual desktop image. The final texture mapping w values are used by Microsoft DirectX®⁷ to create a depth sensation that results from the plane's rotation, which results in a pre-distorted image being observed as an undistorted rectangular box on the three-dimensional plane of the screen, as will be apparent to one of ordinary skill in the art based on the example transformation algorithm provided in this example.
⁶Microsoft DirectX® is a registered trademark of Microsoft Corporation.

⁷Microsoft DirectX® is a registered trademark of Microsoft Corporation.

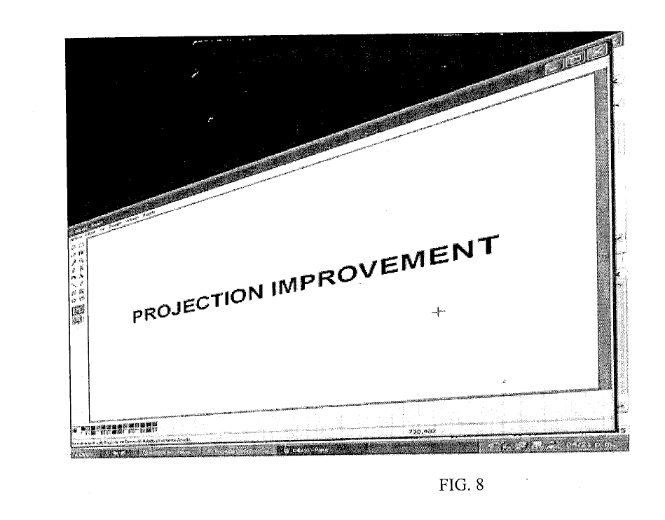

Although the example of FIG. 8 was described using Microsoft DirectX®, other software programs may be utilized, which provide for a texture mapping coordinate to be associated with hardware acceleration found on a video processor of the computer. The hardware accelerator found on a video processor provides for rapid image transformations by dedicated hardware commonly found in modern computers. A program may be written for a specific video processor or for a standard video processor hardware accelerator.

Many other examples and variations of the present invention are included within the scope of the present invention and result from combinations and variations of the examples given.

What is claimed is:

1. An image display system for manipulation of a distorted image by a user, the system comprising:
a computer;
a video display processor operatively coupled to the computer;
a display operatively coupled to the video display processor;
an input device operatively coupled to the computer and capable of manipulating the image; and
a transformation processor capable of transforming the image on the display by the video display processor in three dimensions, when the user operates the input device to manipulate the image to remove distortions.

2. The system of claim 1, wherein the transformation processor is a video hardware accelerator under control of a software program using at least a texture mapping coordinate, a vertical coordinate and a horizontal coordinate to remap the coordinates of the image.

3. The system of claim 1, further comprising:
a user interface, wherein the user interface comprises a plurality of grid points, each of the plurality of grid points being associated with a point on the image and being capable of selection by the input device.

4. The system of claim 3, wherein the user is capable of selecting and moving one of the plurality of grid points using the user interface, such that moving one of the plurality of grid points defines a transformation algorithm for the transformation processor wherein the image is manipulated by the transformation algorithm and subsequent images are continuously manipulated by the transformation algorithm, until the user redefines a new transformation algorithm using the user interface.

5. The system of claim 4, wherein the subsequent images are manipulated in real time.

6. The system of claim 5, wherein the subsequent images include video.

7. The system of claim 1, wherein the input device is a pointing device.

8. The system of claim 1, wherein the display includes a projector for display of the images on a projector surface.

9. The system of claim 8, further comprising a monitor, and the image displayed on the monitor is a pre-distorted image and the image displayed by the projector is a distorted image on the projector surface, and the system is capable of displaying the image such that the image appears undistorted on the projector surface using input from the user.

10. The system of claim 9, wherein the user interface comprises a plurality of grid points, each of the plurality of grid points being associated with a point on the image and being capable of selection by the input device such that one of the plurality of grid points is selected and moved by the input device to distort the pre-distorted image and the image is manipulated by the transformation processor, wherein the distorted image is transformable by application of an image transform in the transformation processor.

11. The system of claim 10, wherein the image transform is applied in a hardware accelerator of the video display processor in real time using three-dimensional transforms.

12. The system of claim 11, wherein the three-dimensional transforms include at least vertical coordinates, horizontal coordinates and depth coordinates for each pixel, wherein the depth coordinates provide a coordinate of a three-dimensional depth from the user.

13. The system of claim 12, wherein changes to the image are continuously updated in real time after application of the three-dimensional transforms.

14. The system of claim 3, wherein the user interface comprises a system capable of rotating the image about a point selected by the input device.

15. The system of claim 3, wherein the user interface comprises a system capable of resizing the image by selecting and moving one or more of the plurality of points individually or jointly using the input device.

16. The system of claim 15, wherein the user interface is capable of moving more than one of the plurality of points jointly by selecting more than one point using the input device.

17. The system of claim 16, wherein the user interface is capable of displacing the image by selecting more than one point using the input device.

18. The system of claim 15, wherein the user interface is capable of manipulating the image to display a mirror image using the input device.

19. The system of claim 3, wherein the user interface includes an overlay system of displaying at least one overlay on the image.

20. The system of claim 19, wherein the overlay system is capable of displaying a video overlay.
